(19) United States
(12) Patent Application Publication
(10) Pub. No.: US 2014/0038078 A1
(43) Pub. Date: Feb. 6, 2014

(54) SHAPE CONTROLLED CORE-SHELL CATALYSTS

(71) Applicant: Minhua Shao, Farmington, CT (US)

(72) Inventor: Minhua Shao, Farmington, CT (US)

(73) Assignee: United Technologies Corporation, Hartford, CT (US)

(21) Appl. No.: 14/112,075

(22) PCT Filed: Apr. 18, 2011
(86) PCT No.: PCT/US2011/032849

§ 371 Date: Oct. 16, 2013

(51) Int. Cl. H01M 4/92

(52) U.S. Cl. CPC H01M 4/928
USPC 429/482; 429/524

(57) ABSTRACT

A catalytic particle for a fuel cell includes a palladium nanoparticle core and a platinum shell. The palladium nanoparticle core has an increased area of {100} or {111} surfaces compared to a cubo-octahedral. The platinum shell is on an outer surface of the palladium nanoparticle core. The platinum shell is formed by deposition of an atomically thin layer of platinum atoms covering the majority of the outer surface of the palladium nanoparticle.

### BACKGROUND

A unitized electrode assembly for a fuel cell includes an anode, a cathode and an electrolyte between the anode and cathode. In one example, hydrogen gas is fed to the anode, and air or pure oxygen is fed to the cathode. However, it is recognized that other types of fuels and oxidants can be used. At the anode, an anode catalyst causes the hydrogen molecules to split into protons (H⁺) and electrons (e⁻). The protons pass through the electrolyte to the cathode while the electrons travel through an external circuit to the cathode, resulting in production of electricity. At the cathode, a cathode catalyst causes the oxygen molecules to react with the protons and electrons from the anode to form water, which is removed from the system.

The anode catalyst and cathode catalyst commonly include platinum or a platinum alloy. Platinum is a high-cost precious metal. Much work has been conducted to reduce the platinum loading in the cathode in order to reduce manufacturing costs. Additionally, work has been conducted to improve the kinetics of oxygen reduction in platinum oxygen-reducing cathode in order to improve the efficiency of the fuel cell.

### SUMMARY

A catalytic particle for a fuel cell includes a palladium nanoparticle core and a platinum shell. The palladium nanoparticle core has an increased area of {100} or {111} surfaces compared to a cubo-octahedral. The platinum shell is on an outer surface of the palladium nanoparticle core. The platinum shell is formed by deposition of an atomically thin layer of platinum atoms covering the majority of the outer surface of the palladium nanoparticle.

### BRIEF DESCRIPTION OF THE DRAWINGS

FIG. 1 is a perspective view of a fuel cell repeat unit having a catalyst layer.

FIG. 2 is an enlarged cross-sectional view of a core-shell catalytic nanoparticle having an enriched {100} structure for use in the catalyst of FIG. 1.

FIG. 3 illustrates a deposition process for forming the core-shell catalytic nanoparticles of FIG. 2.

FIG. 4A-FIG. 4D are schematics of a core nanoparticle having an enriched {100} structure as it undergoes the deposition process of FIG. 3.

FIG. 5 is an enlarged cross-sectional view of a core-shell catalytic nanoparticle having an enriched {111} structure.

FIG. 6A-FIG. 6D are schematics of a core nanoparticle having an enriched {111} structure as it undergoes the deposition process of FIG. 3.

### DETAILED DESCRIPTION

Catalyst nanoparticles having a shape-controlled palladium core and a platinum shell are described herein for use in a fuel cell. Platinum has been used in the anode and cathode of fuel cells to promote the rates of the electrochemical reactions. As described further below, the core-shell structure reduces material costs and improves the oxygen reduction reaction (ORR) activity. The palladium core is shape-controlled to be a {100} enriched structure or a {111} enriched structure compared to a cubo-octahedron nanoparticle. The platinum shell generally follows the surface of the palladium core so that the shell, and the resulting catalyst nanoparticles, has a structure similar to that of the palladium core. The shape-controlled palladium core can be selected based on the electrolyte in order to further increase the oxidation reduction reaction (ORR) activity.

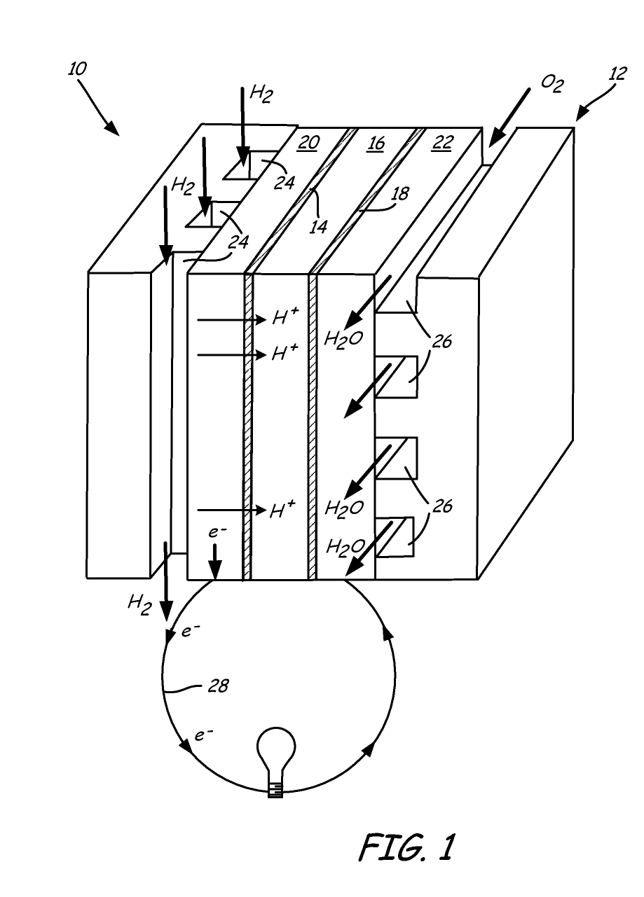

Fuel cells convert chemical energy to electrical energy using one or more fuel cell repeat units. FIG. 1 illustrates a perspective view of one example fuel cell repeat unit 10, which includes unitized electrode assembly (UEA) 12 (having anode catalyst layer (CL) 14, electrolyte 16, cathode catalyst layer (CL) 18, anode gas diffusion layer (GDL) 20 and cathode gas diffusion layer (GDL) 22), anode flow field 24 and cathode flow field 26. Fuel cell repeat unit 10 can have coolant flow fields adjacent to anode flow field 24 and cathode flow field 26. Coolant flow fields are not illustrated in FIG. 1.

Anode GDL 20 faces anode flow field 24 and cathode GDL 22 faces cathode flow field 26. Anode CL 14 is positioned between anode GDL 20 and electrolyte 16, and cathode CL 18 is positioned between cathode GDL 22 and electrolyte 16. This assembly, once bonded together by known techniques, is known as a unitized electrode assembly (UEA) 12. In one example, fuel cell repeat unit 10 is a proton exchange membrane fuel cell (PEMFC) that uses hydrogen fuel (i.e., hydrogen gas) and oxygen oxidant (i.e., oxygen gas or air). It is recognized that fuel cell repeat unit 10 can use alternative fuels and/or oxidants.

In operation, anode GDL 20 receives hydrogen gas (H₂) by way of anode flow field 24. Anode CL 14, which contains a catalyst such as platinum, causes the hydrogen molecules to split into protons (H⁺) and electrons (e⁻). The protons and electrons travel to cathode CL 18; the protons pass through electrolyte 16 to cathode CL 18, while the electrons travel through external circuit 28, resulting in a production of electrical power. Air or pure oxygen (O₂) is supplied to cathode GDL 22 through cathode flow field 26. At cathode CL 18, oxygen molecules react with the protons and electrons from anode CL 14 to form water (H₂O), which then exits fuel cell 10, along with excess heat.

Electrolyte 16 is located between anode CL 14 and cathode CL 18. Electrolyte 16 allows movement of protons and water but does not conduct electrons. Protons and water from anode CL 14 can move through electrolyte 16 to cathode CL 18. Electrolyte 16 can be a liquid, such as phosphoric acid, or a solid membrane, such as a perfluorosulfonic acid (PFSA)-containing polymer or ionomer. PFSA polymers are composed of fluorocarbon backbones with sulfonate groups attached to short fluorocarbon side chains. Example PFSA polymers include Nafion® by E.I. DuPont, USA. Electrolyte 16 can be classified as an absorption electrolyte or a non-absorption electrolyte. Absorption electrolytes include but are not limited to sulfuric acid and phosphoric acid. Non-absorption electrolytes include but are not limited to PFSA polymers and perchloric acid.

Anode CL 14 is adjacent to the anode side of electrolyte 16. Anode CL 14 includes a catalyst, which promotes electrochemical oxidation of fuel (i.e., hydrogen). Example catalysts for anode CL 14 include carbon supported platinum atoms and the core shell catalyst nanoparticles below for cathode CL 18.

Cathode CL 18 is adjacent to the cathode side of electrolyte 16, and opposite anode CL 14. Cathode CL 18 includes a catalyst that promotes electrochemical reduction of oxidant (i.e., oxygen). Cathode CL 18 includes core-shell catalyst nanoparticles which are tailored to electrolyte 16.

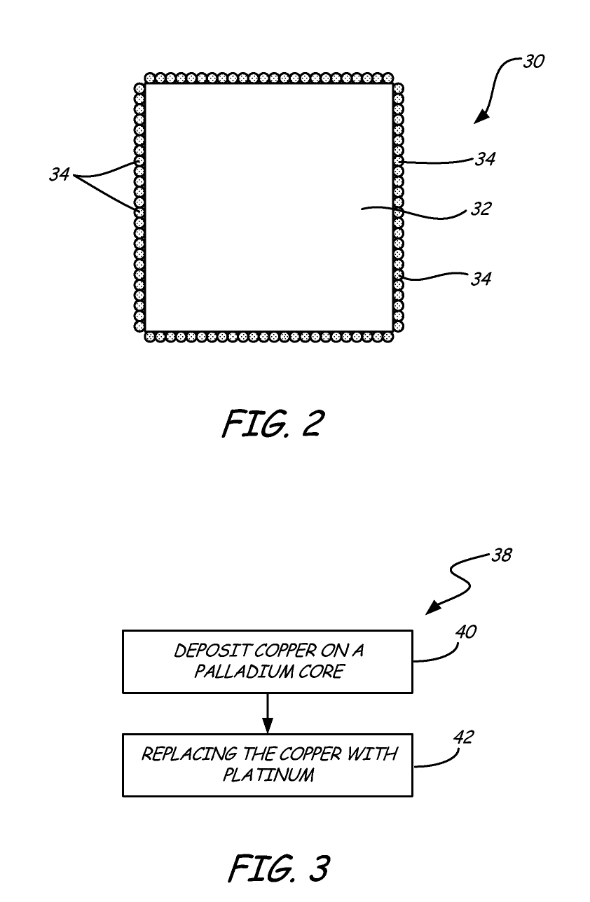

FIG. 2 is an enlarged cross-sectional view of core-shell catalytic nanoparticle 30 having core 32 and platinum atoms 34. Core 32 is formed from palladium or a palladium alloy. Core 32 is a nanoparticle having a {100} enriched structure as compared to a cubo-octahedron. For example, core 32 can have a generally cubic shape. The size of a cubic nanoparticle is determined by the length of the edge. In one example, core 32 has an edge length between about 2 nanometers and about 50 nanometers.

A cubic nanoparticle is bound by six {100} crystal planes. Core 32 may not be a perfect cube. In one example, at least about 30% of the surfaces of core 32 are {100} surfaces. In another example, at least about 50% of the surfaces of core 32 are {100} surfaces. In a further example, at least about 70% of the surfaces of core 32 are {100} surfaces.

Platinum atoms 34 form an atomically thin layer or shell on core 32. Platinum atoms 34 cover essentially the entire outer surface of core 32. In FIG. 2, platinum atoms 34 form a monolayer on core 32. However, platinum atoms 34 may also form a bilayer, trilayer or even cluster on core 32. Atoms of a platinum alloy can be used in place of platinum atoms 34. Nanoparticle 30 has an improved activity towards oxygen reduction compared to previous carbon supported platinum catalysts. Further, the core-shell structure of nanoparticle 30 reduces platinum usage, and thus material costs.

Platinum atoms 34 are atomically deposited on core 32 so that the crystal planes of the platinum shell formed by platinum atoms 34 are essentially the same as that of core 32. That is, the resulting core-shell catalytic nanoparticle 30 has essentially the same {100} enriched structure as core 32. Core-shell catalytic nanoparticle 30 can have a generally cubic shape. Alternately, core-shell catalytic nanoparticle 30 can have an increased number of {100} surfaces compared to a cubo-octahedron. In one example, at least about 30% of the surfaces of core-shell catalytic nanoparticle 30 are {100} surfaces. That is, at least about 30% of the surfaces by area are bound by a {100} plane. In another example, at least about 50% of the surfaces of core-shell catalytic nanoparticle 30 are {100} surfaces. In a further example, at least about 70% of the surfaces of core-shell catalytic nanoparticle 30 are {100} surfaces. Core-shell catalytic nanoparticle 30 having an enriched {100} structure or cubic structure are used with absorption electrolytes, such as sulfuric acid and phosphoric acid, because these electrolytes only weakly or do not absorb on {100} surfaces of platinum.

In a fuel cell, the ORR activity is influenced, in part, by a combination of the type of electrolyte 16 and the shape of core-shell catalytic nanoparticles 30. During use, electrolyte 16 absorbs on the surfaces of core-shell catalytic nanoparticles 30. Once electrolyte 16 absorbs on the surface, the surface sites of core-shell catalytic nanoparticle 30 are no longer available for reaction and the ORR activity decreases. The strength of the absorption depends on the structure of electrolyte 16 and the structure of the surfaces or facets of core-shell catalytic nanoparticles 30. For example, phosphoric acid and sulfuric acid electrolytes weakly or do not absorb on {100} surfaces because the structure of these electrolytes do not match the structure of the {100} surfaces. In comparison, sulfuric acid and phosphoric acid electrolytes strongly absorb on {111} surfaces.

Matching the shape of the catalytic nanoparticles with the electrolyte 16 improves the ORR activity of platinum atoms 34. Previously, generally cubo-octahedron catalytic nanoparticles have been used in fuel cells. Cubo-octahedron nanoparticles contain a mixture of {100} surfaces and {111} surfaces. Generally, cubo-octahedron nanoparticles contain less than 15% {100} surfaces by area. Compared to a cubo-octahedron, core-shell catalytic nanoparticles 30 contain a greater amount of {100} surfaces by area. In one experiment, cubo-octahedron catalytic nanoparticles having a palladium core and a platinum monolayer were compared with core-shell catalytic nanoparticles 30, which had {100} enriched structures. A 0.5M sulfuric acid solution was used as the electrolyte. The cubo-octahedron catalytic nanoparticles had a specific activity of 0.05 mA/cm² at 0.9 V. Core-shell catalytic nanoparticles 30 had a specific activity of 0.1 mA/cm² at 0.9 V. The {100} enriched structure of core-shell catalytic nanoparticles 30 resulted in a two-fold enhancement in activity with the absorption electrolyte (i.e., sulfuric acid) used.

Core-shell catalytic nanoparticle 30 can be formed by method 38 of FIG. 3, which includes depositing copper on a palladium core by underpotential deposition (step 40), and replacing or displacing the copper with platinum to form core-shell catalytic nanoparticle 30 of FIG. 2 (step 42).

Underpotential deposition is an electrochemical process that results in the deposition of one or two monolayers of a metal onto the surface of another metal at a potential positive of the thermodynamic potential for the reaction. In method 38, only one monolayer of copper is deposited on a palladium core. Thermodynamically, underpotential deposition occurs because the work function of copper is lower than that of the palladium nanoparticles.

In step 40, copper is deposited as a continuous or semi-continuous monolayer of copper atoms on the palladium core. In one example, palladium cores deposited on an electrically conductive substrate were placed in a solution consisting of 0.05 M CuSO₄+0.05 M H₂SO₄ saturated with argon and the potential was controlled at 0.1 V (vs. Ag/AgCl, 3M) for 5 minutes resulting in the underpotential deposition of copper on the palladium cores.

Next in step 42, platinum is deposited on the palladium core by displacing the copper atoms, and core-shell catalytic nanoparticle 30 of FIG. 2 is formed. Through an oxidation reduction reaction, platinum atoms displace the copper atoms on the palladium core. For example, the palladium cores can be mixed with an aqueous solution containing a platinum salt. In a specific example, the platinum solution is 2 mM PtK₂Cl₄+0.05 M H₂SO₄ saturated with argon. Platinum ions of the solution are spontaneous reduced by copper as shown in equation (1), and platinum replaces copper on the palladium core.

Cu+Pt²⁺→Pt+Cu²⁺ (1)

The platinum atoms are deposited as an atomically thin layer on the palladium core. In one example, the atomically thin layer is a platinum monolayer. The platinum monolayer generally covers the palladium core. However, some portions of the palladium core may not be covered. Repeating steps 40 and 42, including the under potential deposition of copper atoms and displacing the copper with platinum, results in the deposition of additional platinum layers on the palladium core. For example, a bilayer of platinum atoms can be formed on the palladium core by performing steps 40 and 42 two times, and a trilayer of platinum atoms can be formed by performing steps 40 and 42 three times.

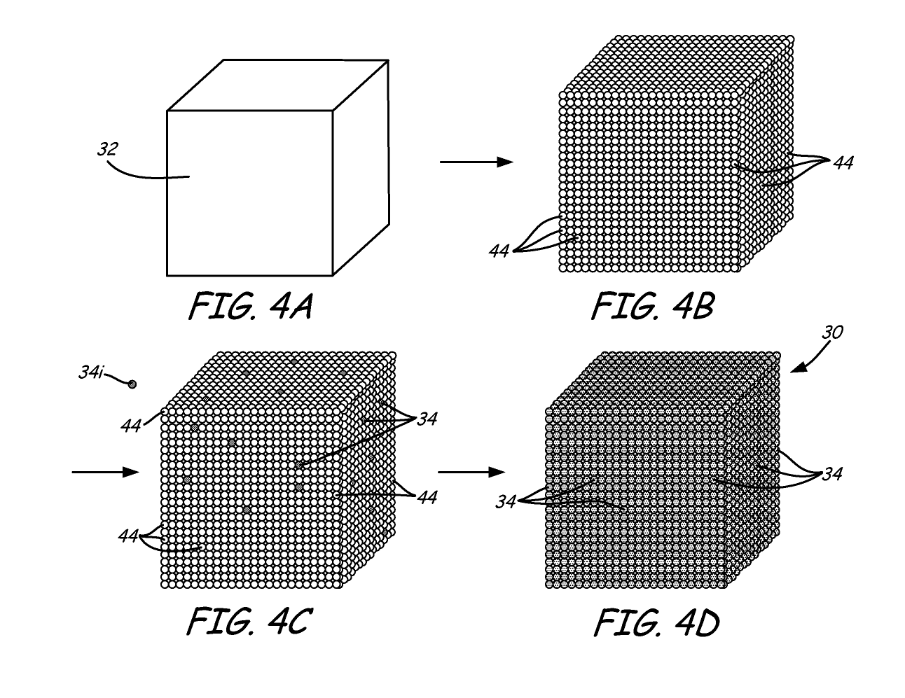

FIG. 4A-FIG. 4D illustrate core 32 as it undergoes method 38. FIG. 4A illustrates core 32 at the beginning of the process. As described above, core 32 is a nanoparticle formed of palladium or a palladium alloy. In one example, core 32 has an edge length between about 2 nanometers and about 50 nanometers. Core 32 has a {100} enriched structure compared to a cubo-octahedron. That is, core 32 has more {100} surfaces by area than a cubo-octahedron. In one example, core 32 contains at least about 30% {100} surfaces by area. In another example, core 32 contains at least about 50% {100} surfaces by area. In a further example, core 32 contains at least about 70% {100} surfaces by area.

Copper atoms 44 are deposited on core 32 by underpotential deposition to form the structure shown in FIG. 4B. One copper atom 44 absorbs on each palladium atom on the surface of core 32. Copper atoms 44 form an atomically thin layer on core 32, such as a monolayer. The resulting copper covered nanoparticle has essentially the same surfaces or lattice planes as core 32.

In FIG. 4C, platinum ions 34i (i.e., the form of a platinum salt) are mixed with the copper covered nanoparticle of FIG. 4B. Platinum ions 34i are spontaneously reduced by copper atoms 44, and platinum atoms 34 replace copper atoms 44 on core 32. Platinum atoms 34 form an atomically thin layer on core 32. In one example, platinum atoms 34 form a monolayer on core 32. Platinum atoms 34 form a shell on core 32 having essentially the same surfaces or structure as core 32. Thus, core-shell catalytic nanoparticle 30 has a {100} enriched structure that is generally similar to that of core 32. Because platinum atoms 34 are atomically deposited, the lattice planes of core-shell catalytic nanoparticle 30 are substantially similar to those of core 32.

As described above, core-shell catalytic nanoparticles 30 having a {100} enriched structure or generally cubic shape are used when electrolyte 16 is an absorption electrolyte such as sulfuric acid and phosphoric acid. When electrolyte 16 is a non-absorption electrolyte, such as a PFSA polymer or perchloric acid, core-shell catalytic nanoparticles having a {111} enriched structure are used.

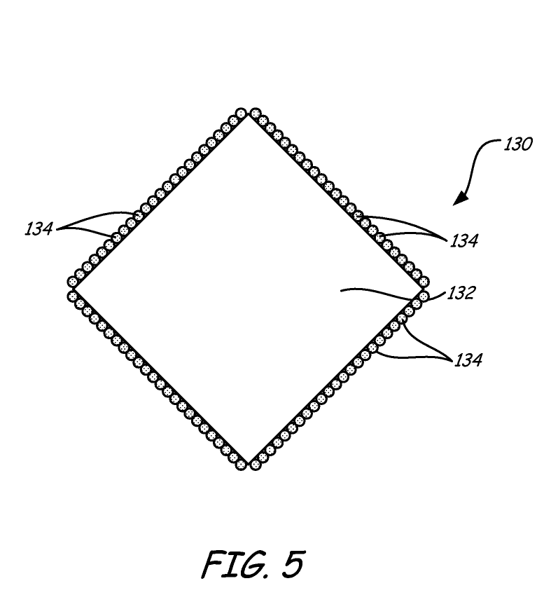

FIG. 5 is a cross-sectional view of core-shell catalytic nanoparticle 130 which includes core 132 and platinum atoms 134. Core 132 is formed from palladium or a palladium alloy, and is a nanoparticle. The size of core 132 is determined by the length of the edge. In one example, core 132 has an edge length between about 2 nanometers and about 50 nanometers.

Core 132 is a {111} enriched structure compared to a cubo-octahedron. That is, core 132 has a larger amount of {111} surfaces by area than a cubo-octahedron. In one example, at least about 50% of core 132 by area are {111} surfaces. In another example, at least about 70% of core 132 by area are {111} surfaces. In a further example, core 132 is a tetrahedral or an octahedral, in which all surfaces of core 132 are {111} surfaces.

Platinum atoms 134 form an atomically thin layer or shell on core 132. Platinum atoms 134 cover essentially the entire outer surface of core 132. In FIG. 2, platinum atoms 134 form a monolayer on core 132. However, platinum atoms 134 may also form a bilayer, trilayer or even cluster on core 132. Further, atoms of a platinum alloy can be used in place of platinum atoms 134.

Platinum atoms 134 are atomically deposited on core 132 according to method 38 presented above. As described above, because platinum atoms 134 are atomically deposited, platinum atoms 134 form surfaces essentially that same as those of core 132. Thus, core-shell catalytic nanoparticle 130 has an enriched {111} structure similar to that of core 132. The core-shell structure of nanoparticle 130 reduces platinum usage, and thus material costs. Further, core-shell nanoparticle 130 has an enhanced activity towards oxygen reduction compared to previous carbon supported platinum catalysts when a non-absorbent electrolyte is used. This is most likely because the intrinsic activity of {111} surfaces is more active than {100} surfaces without adsorbates.

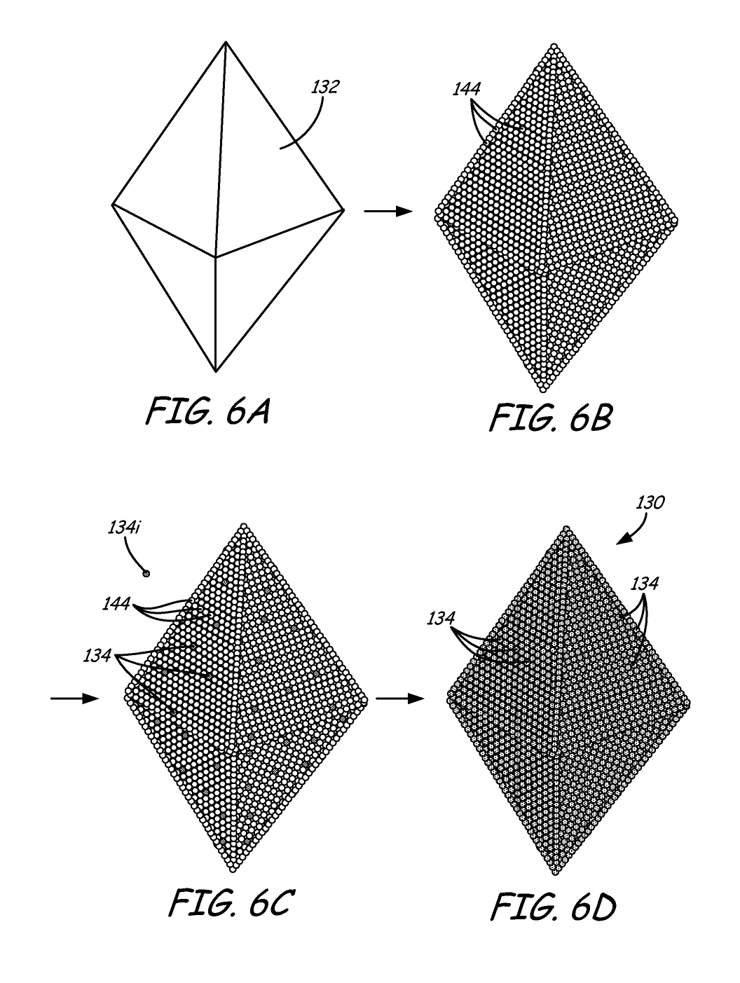

FIG. 6A-FIG. 6D illustrate core 132 as it moves through process 38. In FIG. 6A, core 132 is an octahedron consisting of eight {111} surfaces. As discussed above, core 132 is a {111} enriched palladium or palladium alloy structure and may not be a perfect octahedron or tetrahedron. More surface area of core 132 is bound by {111} crystal planes than in a cubo-octahedron. In one example, at least about 50% by area of the surfaces of core 132 are {111} surfaces (i.e., surfaces bound by {111} surfaces. In another example, at least about 70% by area of the surfaces of core 132 are {111} surfaces.

Copper atoms 144 are deposited on the outer surface of core 132 in FIG. 6B. Copper atoms 144 generally follow the outer surface of core 132. Copper atoms 144 cover substantially the entire outer surface of core 132. The resulting copper covered nanoparticle is bound by planes similar to those of core 132.

In FIG. 6C, platinum ions 134i are mixed with the nanoparticle of FIG. 6B. Copper atoms 144 reduce platinum ions 134i, and platinum atoms 134 replace copper atoms 144 on core 132.

In FIG. 6D, all copper atoms 144 have been replaced with platinum atoms 134 to form core-shell nanoparticle 130. Platinum atoms 134 form an atomically thin layer, such as a monolayer, on core 132. Because platinum atoms 134 are atomically deposited, platinum atoms 134 generally follow the outer surface of core 132. Further, resulting core-shell catalytic nanoparticles 130 are bound by substantially the same planes as core 132. In one example, 50% or more of the surfaces of core-shell catalytic nanoparticle 130 by area are {111} surfaces. In another example, 70% or more of the surfaces of core-shell catalytic nanoparticle 130 by area are {111} surfaces.

As discussed above, core-shell catalytic nanoparticle 130 having a {111} enriched structure is used when electrolyte 16 is a non-absorption electrolyte such as PFSA polymers and perchloric acid (HClO₄).

In one experiment, cubo-octahedral core-shell catalyst particles having a palladium core and a platinum shell were compared to core-shell catalytic nanoparticles 30 and core-shell catalytic nanoparticles 130. The experiment was conducted using 0.1 M HClO₄ solution. The cubo-octahedral core-shell catalyst particles had a platinum mass activity of 0.8 A/mg Pt at 0.9 V. Core-shell catalytic nanoparticles 30 having a cube structure and core-shell catalytic nanoparticles 130 having an octahedral structure had platinum mass activities of 0.6 A/mg Pt and 2.2 A/mg Pt, respectively, at 0.9 V. The results show that a fuel cell having a non-absorption electrolyte and core-shell catalytic nanoparticles having {111} enriched structures had a higher ORR activity compared to the other core-shell catalytic nanoparticles. Specifically, nanoparticles having {111} enriched structures (i.e., octahedral structures) had a higher mass activity than {100} enriched structures and cubo-octahedral when used with a non-absorption electrolyte.

Although the present invention has been described with reference to preferred embodiments, workers skilled in the art will recognize that changes may be made in form and detail without departing from the spirit and scope of the invention.

1. A catalytic particle for a fuel cell, the catalytic particle comprising:
a palladium nanoparticle core having an greater surface area of {100} or {111} surfaces compared to a cubo-octahedral; and
a platinum shell on an outer surface of the palladium nanoparticle core formed by deposition of an atomically thin layer of platinum atoms and covering the majority of the outer surface of the palladium nanoparticle.

2. The catalytic particle of claim 1, wherein the palladium nanoparticle core contains at least 30% {100} surfaces by area.

3. The catalytic particle of claim 1, wherein the palladium nanoparticle core contains at least 50% {100} surfaces by area.

4. The catalytic particle of claim 1, wherein the palladium nanoparticle core contains at least 70% {100} surfaces by area.

5. The catalytic particle of claim 1, wherein the palladium nanoparticle core contains at least 50% {111} surfaces by area.

6. The catalytic particle of claim 1, wherein the palladium nanoparticle core contains at least 70% {111} surfaces by area.

7. A unitized electrode assembly (UEA) for a fuel cell, the UEA comprising:
an anode electrode;
a cathode electrode;
an electrolyte positioned between the cathode electrode and the anode electrode; and
catalytic particles between the electrolyte and one of the anode electrode and the cathode electrode, the catalytic particles comprising:
a palladium core that is a {100} enriched structure or a {111} enriched structure compared to a cubo-octahedron; and
an atomically thin layer of platinum atoms covering a majority of an outer surface of the palladium core to form a shell, the shell having the same crystal planes as the outer surface it covers.

8. The UEA of claim 7, wherein the electrolyte is an absorption electrolyte and the palladium core is the {100} enriched structure.

9. The UEA of claim 8, wherein at least about 30% of surfaces binding the palladium core by area are {100} surfaces.

10. The UEA of claim 8, wherein at least about 50% of surfaces binding the palladium core by area are {100} surfaces.

11. The UEA of claim 8, wherein at least about 70% of surfaces binding the palladium core by area are {100} surfaces.

12. The UEA of claim 8, wherein the absorption electrolyte is selected from the group comprising a sulfuric acid electrolyte and a phosphoric acid electrolyte.

13. The UEA of claim 7, wherein the electrolyte is a non-absorption electrolyte and the palladium core is the {111} enriched structure.

14. The UEA of claim 13, wherein at least about 50% of surfaces binding the palladium core by area are {111} surfaces.

15. The UEA of claim 13, wherein at least about 70% of surfaces binding the palladium core by area are {111} surfaces.

16. The UEA of claim 13, wherein the non-absorption electrolyte is selected from a perfluorosulfonic acid polymer and a perchloric acid electrolyte.

17. The UEA of claim 7, wherein the platinum atoms are atomically deposited on the palladium core.

18. A unitized electrode assembly (UEA) for a fuel cell, the UEA comprising:
an anode electrode;
a cathode electrode;
an electrolyte positioned between the cathode electrode and the anode electrode; and
catalytic particles between the electrolyte and one of the anode electrode and the cathode electrode, the catalytic particles comprising:
a palladium nanoparticle core having at least 30% {100} surfaces by area or at least 50% {111} surfaces by area; and
an atomically thin layer of platinum atoms covering a majority of an outer surface of the palladium core to form a shell, the shell having the same crystal planes as the outer surface it covers.

19. The UEA of claim 18, wherein the electrolyte is an absorption electrolyte and the palladium core has at least 30% {100} surfaces by area.

20. The UEA of claim 18, wherein the electrolyte is a non-absorption electrolyte and the palladium core has at least 50% {111} surfaces by area.
